(19) United States
(12) Patent Application Publication
(10) Pub. No.: US 2025/0028421 A1
(43) Pub. Date: Jan. 23, 2025

(54) DISPLAY METHOD AND APPARATUS, ELECTRONIC DEVICE AND STORAGE MEDIUM

(71) Applicant: BEIJING BYTEDANCE NETWORK TECHNOLOGY CO., LTD., Beijing (CN)

(72) Inventors: Liyou XU, Beijing (CN); Yitong LI, Beijing (CN); Xuanmeng XIE, Beijing (CN); Xiankang YANG, Beijing (CN)

(21) Appl. No.: 18/708,887

(22) PCT Filed: Nov. 8, 2022
(86) PCT No.: PCT/CN2022/130577

§ 371 Date: May 9, 2024

(30) Foreign Application Priority Data
Nov. 10, 2021 (CN) 202111328560.6

(51) Int. Cl. G06F 3/0481; A63F 13/52

(52) U.S. Cl. CPC G06F 3/0481; A63F 13/52

(57) ABSTRACT

Embodiments of the present disclosure provide a display method and apparatus, an electronic device, and a storage medium. The method includes: receiving a current trigger operation from an online user; controlling a corresponding object to be controlled in a currently displayed first image based on the current trigger operation and a target historical trigger operation to obtain a second image, where the target historical trigger operation is a historical trigger operation performed by an offline user at an interactive node corresponding to the first image; and updating the currently displayed image from the first image to the second image.

### CROSS-REFERENCE TO RELATED APPLICATION(S)

The present application claims priority to Chinese Patent Application No. 202111328560.6, filed with the China National Intellectual Property Administration on Nov. 10, 2021, which is incorporated herein by reference in its entirety.

### FIELD

Embodiments of the present disclosure relate to the field of computer technologies, and for example, to a display method and apparatus, an electronic device, and a storage medium.

### BACKGROUND

Currently, a user can interact with other users in a corresponding program, for example, play games with other users in a same interactive game scene.

However, interaction methods in the related art require a plurality of users to be online simultaneously in order to achieve the interaction of the plurality of users in the same scene, resulting in poor user interaction experience.

### SUMMARY

Embodiments of the present disclosure provide a display method and apparatus, an electronic device, and a storage medium to achieve interaction between an online user and an offline user.

According to a first aspect, an embodiment of the present disclosure provides a display method, which includes:
receiving a current trigger operation from an online user;
controlling a corresponding object to be controlled in a currently displayed first image based on the current trigger operation and a target historical trigger operation to obtain a second image, where the target historical trigger operation is a historical trigger operation performed by an offline user at an interactive node corresponding to the first image; and
updating the currently displayed image from the first image to the second image.

According to a second aspect, an embodiment of the present disclosure further provides a display apparatus, which includes:
an operation receiving module configured to receive a current trigger operation from an online user;
an object control module configured to control a corresponding object to be controlled in a currently displayed first image based on the current trigger operation and a target historical trigger operation to obtain a second image, where the target historical trigger operation is a historical trigger operation performed by an offline user at an interactive node corresponding to the first image; and
an image update module configured to update the currently displayed image from the first image to the second image.

According to a third aspect, an embodiment of the present disclosure further provides an electronic device, which includes:
at least one processor; and
a memory configured to store at least one program, where
the at least one program, when executed by the at least one processor, causes the at least one processor to implement the display method described in the embodiment of the present disclosure.

According to a fourth aspect, an embodiment of the present disclosure further provides a computer-readable storage medium having stored thereon a computer program that, when executed by a processor, causes the display method described in the embodiment of the present disclosure to be implemented.

### BRIEF DESCRIPTION OF THE DRAWINGS

Throughout the drawings, the same or similar reference numerals denote the same or similar elements. It should be understood that the accompanying drawings are schematic and that parts and elements are not necessarily drawn to scale.

FIG. 1 is a schematic flowchart of a display method according to an embodiment of the present disclosure;

FIG. 2 is a schematic flowchart of another display method according to an embodiment of the present disclosure;

FIG. 3 is a schematic diagram of a video frame according to an embodiment of the present disclosure;

FIG. 4 is a block diagram of a structure of a display apparatus according to an embodiment of the present disclosure; and

FIG. 5 is a schematic diagram of a structure of an electronic device according to an embodiment of the present disclosure.

### DETAILED DESCRIPTION OF EMBODIMENTS

Embodiments of the present disclosure are described in more detail below with reference to the accompanying drawings.

It should be understood that the various steps described in the method implementations of the present disclosure may be performed in different orders, and/or performed in parallel. Furthermore, additional steps may be included and/or the execution of the illustrated steps may be omitted in the method implementations. The scope of the present disclosure is not limited in this respect.

The term “include/comprise” used herein and the variations thereof are an open-ended inclusion, namely, “include/comprise but not limited to”. The term “based on” is “at least partially based on”. The term “an embodiment” means “at least one embodiment”. The term “another embodiment” means “at least one another embodiment”. The term “some embodiments” means “at least some embodiments”. Related definitions of the other terms will be given in the description below.

It should be noted that concepts such as “first” and “second” mentioned in the present disclosure are only used to distinguish different apparatuses, modules, or units, and are not used to limit the sequence of functions performed by these apparatuses, modules, or units or interdependence.

It should be noted that the modifiers “one” and “a plurality of” mentioned in the present disclosure are illustrative and not restrictive, and those skilled in the art should understand that unless the context clearly indicates otherwise, the modifiers should be understood as “at least one”.

The names of messages or information exchanged between a plurality of apparatuses in the implementations of the present disclosure are used for illustrative purposes only, and are not used to limit the scope of these messages or information.

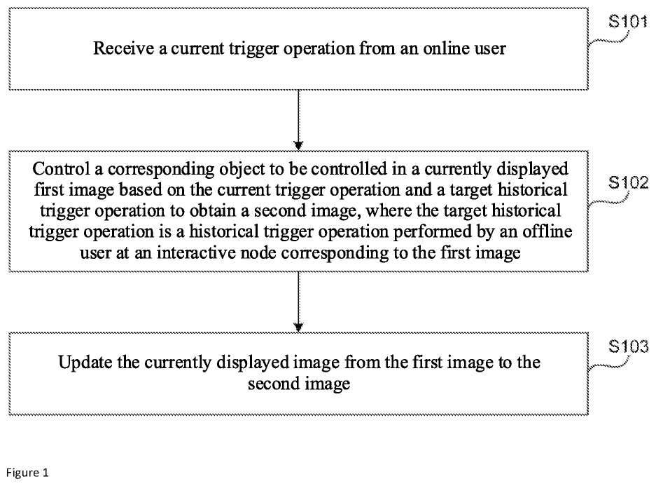

FIG. 1 is a schematic flowchart of a display method according to an embodiment of the present disclosure. The method may be performed by a display apparatus, where the apparatus may be implemented in software and/or hardware, and may be configured in an electronic device, typically in a mobile phone or a tablet computer. The display method provided in this embodiment of the present disclosure is applicable to a scene where an online user interacts with an offline user. As shown in FIG. 1, the display method provided in this embodiment may include the following steps.

In S101, a current trigger operation from an online user is received.

The current trigger operation is a trigger operation received at a current moment, which may be a trigger operation for an object to be controlled in a currently displayed image, that is, a trigger operation for controlling the object to be controlled in the currently displayed image. Correspondingly, the online user may be a user who performs the current trigger operation online, and there may be at least one online user.

In this embodiment, the online user can view an interactive image and perform the trigger operation to interact. For example, after logging in to a game, the online user can view a game image and control an object to be controlled (such an avatar or a control) in the game image. Alternatively, during a process of shooting an interactive video, the online user can view a preview image displayed on a shooting page and interact with video shooting props displayed on the shooting page. In this way, the electronic device can receive the trigger operation from the online user for the object to be controlled in the currently displayed interactive image as the current trigger operation.

In S102, a corresponding object to be controlled in a currently displayed first image is controlled based on the current trigger operation and a target historical trigger operation to obtain a second image, where the target historical trigger operation is a historical trigger operation performed by an offline user at an interactive node corresponding to the first image.

The first image may be a currently displayed image, which may be an image in a current interactive scene. The current interactive scene may be an interactive scene currently entered by the online user, which may be a game scene, a video shooting scene, etc. The second image may be an image obtained by controlling the object to be controlled in the first image based on the current trigger operation and the target historical trigger operation.

The target historical trigger operation may be a historical trigger operation performed by the offline user at the interactive node (such as a game node or a video shooting node) corresponding to the first image. The historical trigger operation can be understood as an interactive operation performed by the offline user in the current interactive scene before the current moment. The offline user may be a user who is not in the current interactive scene at the current moment and with whom the online user wants to interact, and there may be at least one offline user. The object to be controlled may be an interactive object, such as an avatar or a control, displayed in the first image. Different users may correspond to the same object to be controlled or different objects to be controlled. Description is made below by using an example in which different users correspond to different objects to be controlled.

In this embodiment, when a user enters an interactive scene to interact, a trigger operation performed by the user at an interactive node of the interactive scene may be pre-recorded. In this way, when the online user wants to interact with the offline user, the object to be controlled in the interactive scene can be controlled based on the trigger operation performed online by the online user in the interactive scene and the historical trigger operation previously performed by the offline user at the interactive node of the interactive scene, so that the effect of simultaneous online interaction can be created without the need for a plurality of users to be online at the same time, and the needs of the user to play games or create interactive videos together with other users can be satisfied, improving the user experience.

For example, the interactive scene is entering a virtual stage and performing (such as dancing) with others to generate a performance video. At least one online user, after entering the virtual stage, can select at least one offline user who previously performed on the virtual stage to perform together in order to generate a performance video. For example, a user A and a user B can enter the same virtual stage at the same time, and select a user C and a user D, who previously performed on the virtual stage but are not currently online, to perform together. Alternatively, when at least one user wants to interact with at least one offline user, the at least one user may enter a virtual stage previously entered by the at least one offline user. For example, it is assumed that a user C and a user D previously entered a same virtual stage at the same time, successively, or separately, to perform, and a performance video has been generated and posted. That is, the performance video may be one video that contains both an avatar of the user C and an avatar of the user D, or may be two videos that contain the avatar of the user C or the avatar of the user D respectively. When a user A and a user B want to join the performance after viewing the performance video, they can enter the virtual stage in the performance video and perform together. Correspondingly, the electronic device may simultaneously display an avatar of the user A, an avatar of the user B, the avatar of the user C, and the avatar of the user D on the virtual stage, and control the avatar of the user A based on a trigger operation performed online by the user A, control the avatar of the user B based on a trigger operation performed online by the user B, and control the avatar of the user C based on a historical trigger operation performed by the user C when performing in the performance video, and control the avatar of the user D based on a historical trigger operation performed by the user D when performing in the performance video.

In this embodiment, the historical trigger operation performed by the offline user at the interactive node corresponding to the first image may be determined when the first image is displayed. Alternatively, the historical trigger operation performed by the offline user at at least one interactive node of the corresponding interactive scene may be obtained before the current trigger operation from the online user is received, for example, when a trigger operation for creating a video together with the offline user is received, so that when switching to the first image, it is possible to directly control the corresponding object to be controlled in the first image based on the target historical trigger operation performed by the offline user at the interactive node corresponding to the first image, thereby reducing a latency.

In an implementation, before the current trigger operation from the online user is received, the method further includes: determining a historical trigger operation corresponding to at least one historical video frame in a historical interactive video, where the historical trigger operation is a trigger operation performed by the offline user at an interactive node corresponding to the corresponding historical video frame.

The historical interactive video may be understood as a video generated when the offline user interacts in the current interactive scene. The video may be a video that records an interactive image presented to the offline user when the offline user interacts in the current interactive scene. Correspondingly, the historical video frame may be a video frame in the historical interactive video. The historical trigger operation may be a trigger operation performed by the offline user at the interactive node corresponding to the historical video frame.

In the above implementation, a video may be used to record a trigger operation performed by the user at at least one interactive node of the current interactive scene. Thus, it can meet the recording requirements of the trigger operation. In addition, it allows the user to view an interaction performed by an offline user in a corresponding interactive scene by viewing an interactive video posted by other users (including the offline user), and to enter the interactive scene to interact with other users corresponding to avatars in the interactive video to create a new interactive video, which can improve the intuitiveness of the user to view interactive scenes where other users are located and the interactive effects of other users, and improve the convenience for the user to select a scene of interest to create a new interactive video, improving the user experience.

For example, when the offline user interacts in the current interactive scene, a currently displayed image can be periodically obtained based on a switching frequency of a video frame, a video frame of a historical interactive video of the offline user can be generated, a trigger operation performed by the offline user when the electronic device displays the image is used as a trigger operation corresponding to the corresponding video frame, and operation identification information of the trigger operation is recorded. Therefore, when it is determined that the online user wants to create an interactive video with an offline user, a historical interactive video of the offline user and operation identification information corresponding to a historical video frame in the historical interactive video can be obtained. Based on the operation identification information corresponding to the historical video frame, a historical trigger operation corresponding to the historical video frame can be determined. For example, for each historical video frame in the historical interactive video of the offline user, it is determined whether there is corresponding operation identification information for the historical video frame. In response to the presence of the corresponding operation identification information for the historical video frame, the historical trigger operation performed by the offline user at the interactive node corresponding to the historical video frame is determined based on the operation identification information; and in response to the absence of the corresponding operation identification information for the historical video frame, it is determined that the offline user did not perform a trigger operation at the interactive node corresponding to the historical video frame. In the above implementation, after the historical interactive video of the offline user is generated, the historical interactive video and the operation identification information of a historical trigger operation performed by the offline user at an interactive node corresponding to at least one historical video frame in the historical interactive video may be stored in a server. For example, the historical video frame and the operation identification information of the historical trigger operation performed at the interactive node corresponding to the historical video frame are stored in the server, or video frame identification information of the historical video frame in the historical interactive video and the operation identification information of the historical trigger operation performed at the interactive node corresponding to the historical video frame are correspondingly stored in the server. In this way, when a client needs to determine the historical trigger operation corresponding to the historical video frame, the client may send a trigger operation obtaining request for the historical interactive video to the server. Correspondingly, after receiving the trigger operation obtaining request sent by the client, the server may send the operation identification information of the historical trigger operation corresponding to the at least one historical video frame in the historical interactive video to the client. In this case, optionally, the determining a historical trigger operation corresponding to at least one historical video frame in a historical interactive video includes: obtaining, from a server, operation identification information corresponding to the at least one historical video frame in the historical interactive video; and using a trigger operation corresponding to the operation identification information as the historical trigger operation corresponding to the corresponding historical video frame.

It can be understood that in this embodiment, the trigger operation performed by the user at at least one interactive node of the current interactive scene may not be recorded with a video; for example, the interactive node in the current interactive scene and the trigger operation performed by the user at the interactive node may be correspondingly recorded, which is not limited in this embodiment.

In S103, the currently displayed image is updated from the first image to the second image.

For example, after obtaining the second image, the currently displayed first image can be updated to the second image. Then, the second image is used as the first image, and the method goes back to S101, so that the user can continue to perform a trigger operation to interact with the offline user.

It should be noted that although this embodiment is described by using an example of updating the image based on the trigger operation from the online user and the target historical trigger operation from the offline user, those skilled in the art should understand that when the current trigger operation is not received, or when there is no target historical trigger operation, image updating can still be performed in this embodiment. For example, if the current trigger operation from the online user is not received at the current interactive node, the corresponding object to be controlled (such as the object to be controlled corresponding to the offline user) in the first image may be controlled based only on the target historical trigger operation from the offline user, to obtain the second image, and the second image is displayed. If there is no target historical interaction operation at the current interactive node, the corresponding object to be controlled (such as the object to be controlled corresponding to the online user) in the first image may be controlled based only on the current trigger operation from the online user, to obtain the second image, and the second image is displayed. If the current trigger operation is not received at the current interactive node and there is no target historical trigger operation, image switching can be performed according to image switching logic when there is no current trigger operation and target historical trigger operation.

For example, the image switching can be performed according to an interaction rule specified in an interaction script. For example, when the first image is displayed, if there is a current trigger operation and/or a target historical trigger operation, the existing current trigger operation and/or the existing target historical trigger operation can be input to the interaction script, to obtain image information to be rendered output by the interaction script according to interaction logic when there is a current trigger operation and/or a target historical trigger operation. If there is no current trigger operation and target historical trigger operation, the image information to be rendered output by the interaction script according to an interaction rule when there is no current trigger operation and/or target historical trigger operation may be obtained. In this way, image rendering can be performed based on the image information to be rendered, to obtain the second image, and the second image is displayed.

According to the display method provided in this embodiment, the current trigger operation from the online user is received, the corresponding control object in the first image is controlled based on the current trigger operation and the target historical trigger operation performed by the offline user at the interactive node corresponding to the currently displayed first image, to obtain the second image, and the currently displayed image is updated from the first image to the second image. According to the technical solution described above, in this embodiment, it is possible to control the corresponding object to be controlled in the image based on the current trigger operation from the online user and the target historical trigger operation from the offline user, so that the effect of simultaneous control by the online user and the offline user can be created without the need for the users to be online at the same time, which can provide convenience for the user to interact with other users, improving the user experience.

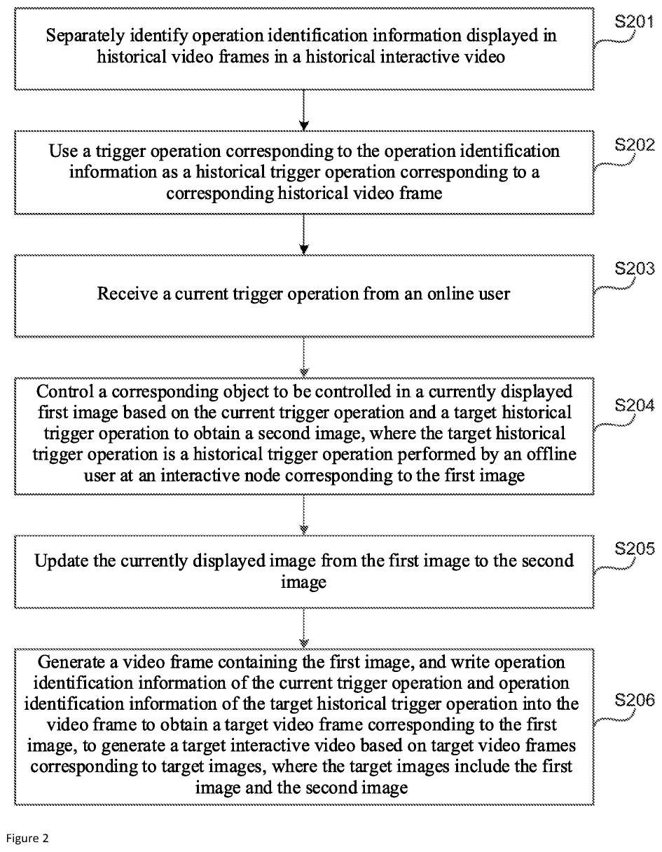

FIG. 2 is a schematic flowchart of another display method according to an embodiment of the present disclosure. The solution in this embodiment can be combined with at least one optional solution in the above embodiment. Optionally, the determining a historical trigger operation corresponding to at least one historical video frame in a historical interactive video includes: separately identifying operation identification information displayed in the at least one historical video frame in the historical interactive video; and using a trigger operation corresponding to the operation identification information as the historical trigger operation corresponding to the corresponding historical video frame.

Optionally, the display method provided in this embodiment may further include: generating a video frame containing the first image, and writing operation identification information of the current trigger operation and operation identification information of the target historical trigger operation into the video frame to obtain a target video frame corresponding to the first image, to generate a target interactive video based on target video frames corresponding to a plurality of target images, where the target images include the first image and the second image.

Correspondingly, as shown in FIG. 2, the display method provided in this embodiment may include the following steps.

In S201, the operation identification information displayed in the at least one historical video frame in the historical interactive video is separately identified.

In this embodiment, when an image is displayed, the trigger operation (including the trigger operation from the online user and/or the trigger operation from the offline user) applied to the object to be controlled in the image can be written into the video frame of the interactive video generated based on the image, instead of additionally storing the operation identification information in the interactive video separately from the interactive video to avoid data loss. Moreover, after obtaining the interactive video, other users may interact, directly based on the interactive video, with the user who performs trigger control in the interactive video, to shoot a new interactive video together, without establishing a connection to the server and obtaining, from the server, operation identification information of at least one user in the interactive video, which can get rid of the restrictions of the network environment and provide convenience for interaction between different users.

For example, the online user can view a historical interactive video posted by the offline user and generated through interaction of at least one user, and enter the interactive scene of the historical interactive video by performing an operation of shooting a video together, to shoot a video with the user in the video together. Correspondingly, when receiving the operation of shooting a video together from the online user for the offline user, the client identifies operation identification information displayed in the at least one historical video frame in the historical interactive video. In addition, when receiving the operation of shooting a video together from the online user, the client can also call an interaction script corresponding to the historical interactive video to construct an interactive scene, display, in the interactive scene, an avatar in the historical interactive video, and create an avatar corresponding to the online user in the interactive scene based on the trigger operation from the online user.

In this embodiment, a display form of the operation identification information of the trigger operation (including the historical trigger operation and/or the current trigger operation) in the video frame can be set as needed. For example, the operation identification information of the trigger operation can be added to the video frame in the form of characters, which is not limited in this embodiment.

Optionally, the operation identification information is displayed in the form of a color block image, color block images corresponding to different trigger operations have different display states, and the trigger operations include the historical trigger operation. In this way, adding the operation identification information to the video frame in the form of a color block image reduces the difficulty of adding the operation identification information, which avoids excessive interference with the user when viewing the video, and reduces the distortion of the operation identification information caused by video compression, improving the anti-fuzziness of the operation identification information. Moreover, subsequently, the trigger operation at the interactive node corresponding to the video frame by the user can be determined by only identifying the display state of the color block image in the video frame, without the need for text recognition, and the recognition speed of operation identification information can also be improved. Color block images corresponding to different trigger operations may have different sizes, shapes, and/or colors, and trigger operations of different users can be displayed in different positions of the video frame. For example, the trigger operations of different users can be displayed in different positions on one side (such as upper, lower, left, or right) of the video frame.

In an implementation, the color block images corresponding to the different trigger operations have different colors, and the separately identifying operation identification information displayed in the at least one historical video frame in the historical interactive video includes: for each of the at least one historical video frame in the historical interactive video, identifying a historical color block image displayed in a preset area of the historical video frame, and determining a plurality of color component values for a center pixel in the historical color block image; separately determining component value intervals in which the plurality of color component values are located; and using characteristic component values of the plurality of component value intervals as the operation identification information displayed in the historical video frame, where different component value intervals have different characteristic component values.

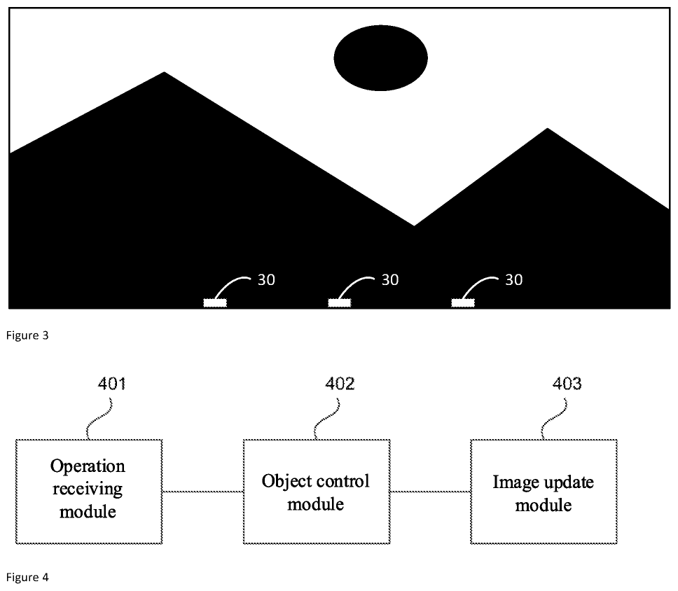

In the above implementation, as shown in FIG. 3 (where color block images 30 are shown at the bottom of a video frame as an example), the color block images 30 of different colors can represent different types of trigger operations, and the color block images 30 in different positions can represent trigger operations from different users. For example, the pixels in each color block image 30 are set to have the same color, the different trigger operations are set to correspond to color block images 30 of different colors, and the color block images 30 corresponding to the trigger operations from different users are set to be located in different positions of the video frame.

The historical color block image can be understood as a color block image displayed in the historical video frame. The center pixel in the historical color block image may be a pixel located at the center of the historical color block image. Each color component can contain a plurality of component value intervals. Each component value interval can have one characteristic component value. The component value interval of the color component and the characteristic component value of the component value interval can be flexibly set as needed. Different component value intervals can have different characteristic component values.

For example, for each historical video frame in the historical interactive video, a color block image displayed in a preset area of the historical video frame (such as the bottom area of the historical video frame) is identified. The offline user corresponding to each color block image is determined based on a display position of the color block image, and then, the object to be controlled to which the trigger operation corresponding to the offline user applies is determined. In addition, for each color block image, a center pixel in the color block image and a red color component value R, a green color component value G, and a blue color component value B of the center pixel are determined. For each color component value, a component value interval in which the color component value is located is determined, and the color component value is corrected to the characteristic component value of the component value interval. In this way, after the corrected color component value is obtained, that is, after the correction of each color component value of the center pixel in the historical color block image is completed, the corrected color component value can be used as operation identification information displayed in that position, and the historical trigger operation performed by the corresponding offline user is determined based on the operation identification information.

In the above implementation, only the color component of the center pixel in the color block image is identified, and the operation identification information is determined based on the characteristic component value of the component value interval in which the color component of the center pixel is located, which can ensure that even in the case of a specific degree of color distortion in the color block image, the operation identification information corresponding to the color block image can still be accurately identified. This can effectively cope with the distortion caused by video compression and other processes to the color block image, especially to the pixel located at the edge of the color block image, thereby improving the color accuracy of the final determined color block image, then improving the accuracy of the operation identification information corresponding to the finally identified color block, and avoiding the misidentification of the historical trigger operation caused by video compression.

In S202, the trigger operation corresponding to the operation identification information is used as the historical trigger operation corresponding to the corresponding historical video frame.

In this embodiment, after the operation identification information displayed in the historical video frame is identified, the trigger operation corresponding to the operation identification information can be used as the trigger operation performed at the interactive node corresponding to the historical video frame by the corresponding offline user.

Correspondingly, if the operation identification information is not displayed in a specific historical video frame, for example, if the operation identification information is not identified in the historical video frame, it can be determined that there is no historical trigger operation corresponding to the historical video frame, that is, it is determined that the offline user has not performed a trigger operation at the interactive node corresponding to the historical video frame.

In S203, the current trigger operation from the online user is received.

In S204, a corresponding object to be controlled in the currently displayed first image is controlled based on the current trigger operation and the target historical trigger operation to obtain the second image, where the target historical trigger operation is a historical trigger operation performed by an offline user at an interactive node corresponding to the first image.

In S205, the currently displayed image is updated from the first image to the second image.

In S206, the video frame containing the first image is generated, and the operation identification information of the current trigger operation and the operation identification information of the target historical trigger operation are written into the video frame to obtain the target video frame corresponding to the first image, to generate the target interactive video based on the target video frames corresponding to the plurality of target images, where the plurality of target images include the first image and the second image.

For example, operation identification information of trigger operations performed at a specific interactive node by the online user and the offline user with whom the online user is currently interacting can be recorded in the target video frame corresponding to the interactive node. For example, a video frame corresponding to the current moment can be generated based on the image displayed at a specific moment, and the operation identification information of the trigger operations performed at the interactive node corresponding to the image by the online user and the offline user with whom the online user is currently interacting is written into the video frame in the form of the color block image, to obtain the target video frame at the interactive node in the target interactive video. In this way, after obtaining all target video frames in the target interactive video, the target video frames can be synthesized to obtain a target interactive video in which the online user interacts with the offline user.

It can be understood that the generation timing of the target video frame can be set as needed. For example, in the case of the target video frame corresponding to the first image, S206 can be performed after the current trigger operation from the online user is received, for example, before, after or at the same time when S204 is performed. Alternatively, S206 may be performed for each image displayed during the interaction after the interaction of the online user is completed, which is not limited in this embodiment.

According to the display method provided in this embodiment, writing the operation identification information of the trigger operation performed by the user into the corresponding video frame, without additionally storing the operation identification information separately from the video and obtaining the operation identification information from the server, can reduce dependence on the network environment, improve the convenience for the user to interact with other users, and reduce the amount of information required to be stored, avoiding information loss during transmission.

FIG. 4 is a block diagram of a structure of a display apparatus according to an embodiment of the present disclosure. The apparatus may be implemented by software and/or hardware, may be configured in an electronic device, typically in a mobile phone or a tablet computer, and may implement interaction between an online user and an offline user by performing a display method. As shown in FIG. 4, the display apparatus provided in this embodiment may include: an operation receiving module 401, an object control module 402, and an image update module 403.

The operation receiving module 401 is configured to receive a current trigger operation from an online user.

The object control module 402 is configured to control a corresponding object to be controlled in a currently displayed first image based on the current trigger operation and a target historical trigger operation to obtain a second image, where the target historical trigger operation is a historical trigger operation performed by an offline user at an interactive node corresponding to the first image.

The image update module 403 is configured to update the currently displayed image from the first image to the second image.

The display apparatus provided in this embodiment receives the current trigger operation from the online user by using the operation receiving module; controls, by using the object control module, the corresponding control object in the first image based on the current trigger operation and the target historical trigger operation performed by the offline user at the interactive node corresponding to the currently displayed first image, to obtain the second image, and updates, by using the image update module, the currently displayed image from the first image to the second image. According to the technical solution described above, in this embodiment, it is possible to control the corresponding object to be controlled in the image based on the current trigger operation from the online user and the target historical trigger operation from the offline user, so that the effect of simultaneous control by the online user and the offline user can be created without the need for the users to be online at the same time, which can provide convenience for the user to interact with other users, improving the user experience.

Optionally, the display apparatus provided in this embodiment may further include: an operation determination module configured to: before the current trigger operation from the online user is received. determine a historical trigger operation corresponding to at least one historical video frame in a historical interactive video, where the historical trigger operation is a trigger operation performed by the offline user at an interactive node corresponding to the corresponding historical video frame.

In the above solution, the operation determination module may include: an information identification unit configured to separately identify operation identification information displayed in the at least one historical video frame in the historical interactive video; and a first operation determination unit configured to use a trigger operation corresponding to the operation identification information as the historical trigger operation corresponding to the corresponding historical video frame.

In the above solution, the operation identification information may be displayed in the form of a color block image, color block images corresponding to different trigger operations may have different display states, and the trigger operations may include the historical trigger operation.

In the above solution, different trigger operations may correspond to color block images of different colors, and the information identification unit may include: a component value determination sub-unit configured to: for each of the at least one historical video frame in the historical interactive video. identify a historical color block image displayed in a preset area of the historical video frame, and determine a plurality of color component values for a center pixel in the historical color block image; an interval determination sub-unit configured to separately determine component value intervals in which the plurality of color component values are located; and an information determination sub-unit configured to use characteristic component values of the plurality of component value intervals as the operation identification information displayed in the historical video frame, where different component value intervals have different characteristic component values.

Optionally, the display apparatus provided in this embodiment may further include: an information writing module configured to generate a video frame containing the first image, and write operation identification information of the current trigger operation and operation identification information of the target historical trigger operation into the video frame to obtain a target video frame corresponding to the first image, to generate a target interactive video based on target video frames corresponding to a plurality of target images, where the plurality of target images include the first image and the second image.

In the above solution, the operation determination module may include: an information obtaining unit configured to obtain, from a server, operation identification information corresponding to the at least one historical video frame in the historical interactive video; and a second operation determination unit configured to use a trigger operation corresponding to the operation identification information as the historical trigger operation corresponding to the corresponding historical video frame.

The display apparatus provided in this embodiment of the present disclosure can perform the display method provided in any embodiment of the present disclosure, and has corresponding functional modules for performing the display method. For the technical details not described in detail in this embodiment, reference may be made to the display method provided in any embodiment of the present disclosure.

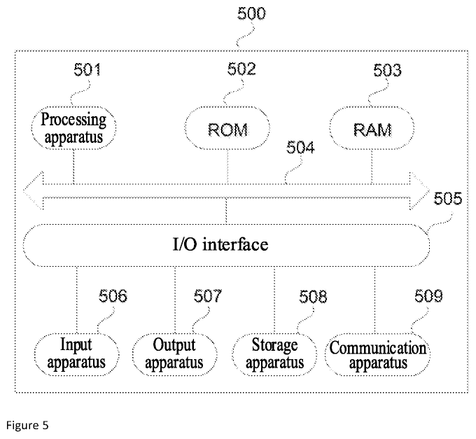

FIG. 5 is a schematic diagram of a structure of an electronic device (e.g., a terminal device) 500 suitable for implementing the embodiments of the present disclosure. The terminal device in this embodiment of the present disclosure may include, but is not limited to, mobile terminals such as a mobile phone, a notebook computer, a digital broadcast receiver, a personal digital assistant (PDA), a tablet computer (PAD), a portable multimedia player (PMP), and a vehicle-mounted terminal (such as a vehicle navigation terminal), and fixed terminals such as a digital television (TV) and a desktop computer. The electronic device shown in FIG. 5 is merely an example, and shall not impose any limitation on the function and scope of use of the embodiments of the present disclosure.

As shown in FIG. 5, the electronic device 500 may include a processing apparatus (e.g., a central processor, a graphics processor, etc.) 501 that may perform a variety of appropriate actions and processing in accordance with a program stored in a read-only memory (ROM) 502 or a program loaded from a storage apparatus 508 into a random access memory (RAM) 503. The RAM 503 further stores various programs and data required for the operation of the electronic device 500. The processing apparatus 501, the ROM 502, and the RAM 503 are connected to each other through a bus 504. An input/output (I/O) interface 505 is also connected to the bus 504.

Generally, the following apparatuses may be connected to the I/O interface 505: an input apparatus 506 including, for example, a touch screen, a touchpad, a keyboard, a mouse, a camera, a microphone, an accelerometer, a gyroscope, etc.; an output apparatus 507, for example, including a liquid crystal display (LCD), a speaker, a vibrator, etc.; a storage apparatus 508, for example, including a tape, a hard disk, etc.; and a communication apparatus 509. The communication apparatus 509 may allow the electronic device 500 to perform wireless or wired communication with other devices to exchange data. Although FIG. 5 shows the electronic device 500 having various apparatuses, it should be understood that it is not required to implement or have all of the shown apparatuses. It may be an alternative to implement or have more or fewer apparatuses.

In particular, according to an embodiment of the present disclosure, the process described above with reference to the flowcharts may be implemented as a computer software program. For example, this embodiment of the present disclosure includes a computer program product, which includes a computer program carried on a non-transitory computer-readable medium, where the computer program includes program code for performing the method shown in the flowchart. In such an embodiment, the computer program may be downloaded and installed from a network through the communication apparatus 509, or installed from the storage apparatus 508, or installed from the ROM 502. When the computer program is executed by the processing apparatus 501, the above-mentioned functions defined in the method of the embodiment of the present disclosure are performed.

It should be noted that the above computer-readable medium described in the present disclosure may be a computer-readable signal medium, or a computer-readable storage medium, or any combination thereof. The computer-readable storage medium may be, for example but not limited to, electric, magnetic, optical, electromagnetic, infrared, or semiconductor systems, apparatuses, or devices, or any combination thereof. A more specific example of the computer-readable storage medium may include, but is not limited to: an electrical connection having at least one wire, a portable computer magnetic disk, a hard disk, a random access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination thereof. In the present disclosure, the computer-readable storage medium may be any tangible medium containing or storing a program which may be used by or in combination with an instruction execution system, apparatus, or device. In the present disclosure, the computer-readable signal medium may include a data signal propagated in a baseband or as a part of a carrier, the data signal carrying computer-readable program code. The propagated data signal may be in various forms, including but not limited to an electromagnetic signal, an optical signal, or any suitable combination thereof. The computer-readable signal medium may also be any computer-readable medium other than the computer-readable storage medium. The computer-readable signal medium can send, propagate, or transmit a program used by or in combination with an instruction execution system, apparatus, or device. The program code contained in the computer-readable medium may be transmitted by any suitable medium, including but not limited to: electric wires, optical cables, radio frequency (RF), etc., or any suitable combination thereof.

In some implementations, the client and the server can communicate using any currently known or future-developed network protocol such as a HyperText Transfer Protocol (HTTP), and can be connected to digital data communication (for example, communication network) in any form or medium. Examples of the communication network include a local area network (LAN), a wide area network (WAN), an internetwork (for example, the Internet), a peer-to-peer network (for example, an ad hoc peer-to-peer network), and any currently known or future-developed network.

The above computer-readable medium may be contained in the above electronic device. Alternatively, the computer-readable medium may exist independently, without being assembled into the electronic device.

The above computer-readable medium carries at least one program, and the at least one program, when executed by the electronic device, causes the electronic device to perform the following: receiving a current trigger operation from an online user; controlling a corresponding object to be controlled in a currently displayed first image based on the current trigger operation and a target historical trigger operation to obtain a second image, where the target historical trigger operation is a historical trigger operation performed by an offline user at an interactive node corresponding to the first image; and updating the currently displayed image from the first image to the second image.

Computer program code for performing operations of the present disclosure can be written in one or more programming languages or a combination thereof, where the programming languages include but are not limited to object-oriented programming languages, such as Java, Smalltalk, and C++, and further include conventional procedural programming languages, such as “C” language or similar programming languages. The program code may be completely executed on a computer of a user, partially executed on a computer of a user, executed as an independent software package, partially executed on a computer of a user and partially executed on a remote computer, or completely executed on a remote computer or server. In the circumstance involving a remote computer, the remote computer may be connected to a computer of a user over any type of network, including a local area network (LAN) or a wide area network (WAN), or may be connected to an external computer (for example, connected over the Internet using an Internet service provider).

The flowcharts and block diagrams in the accompanying drawings illustrate the possibly implemented architecture, functions, and operations of the system, method, and computer program product according to various embodiments of the present disclosure. In this regard, each block in the flowchart or block diagram may represent a module, program segment, or part of code, and the module, program segment, or part of code contains at least one executable instruction for implementing the specified logical functions. It should also be noted that, in some alternative implementations, the functions marked in the blocks may also occur in an order different from that marked in the accompanying drawings. For example, two blocks shown in succession can actually be performed substantially in parallel, or they can sometimes be performed in the reverse order, depending on the functions involved. It should also be noted that each block in the block diagram and/or the flowchart, and a combination of the blocks in the block diagram and/or the flowchart may be implemented by a dedicated hardware-based system that executes specified functions or operations, or may be implemented by a combination of dedicated hardware and computer instructions.

The related units described in the embodiments of the present disclosure may be implemented by means of software, or may be implemented by means of hardware. The name of a module does not constitute a limitation on the unit itself in some cases.

The functions described herein above may be performed at least partially by at least one hardware logic component. For example, without limitation, exemplary types of hardware logic components that may be used include: a field programmable gate array (FPGA), an application specific integrated circuit (ASIC), an application specific standard product (ASSP), a system-on-chip (SOC), a complex programmable logic device (CPLD), and the like.

In the context of the present disclosure, a machine-readable medium may be a tangible medium that may contain or store a program used by or in combination with an instruction execution system, apparatus, or device. A machine-readable medium may be a machine-readable signal medium or a machine-readable storage medium. A machine-readable medium may include, but is not limited to, electronic, magnetic, optical, electromagnetic, infrared, or semiconductor systems, apparatus, or devices, or any suitable combination thereof. More specific examples of a machine-readable storage medium may include an electrical connection based on at least one wire, a portable computer disk, a hard disk, a random access memory (RAM), a read-only memory (ROM), an erasable programmable read-only memory (EPROM or flash memory), an optic fiber, a portable compact disk read-only memory (CD-ROM), an optical storage device, a magnetic storage device, or any suitable combination thereof.

According to at least one embodiment of the present disclosure, Example 1 provides a display method, which includes:
receiving a current trigger operation from an online user;
controlling a corresponding object to be controlled in a currently displayed first image based on the current trigger operation and a target historical trigger operation to obtain a second image, where the target historical trigger operation is a historical trigger operation performed by an offline user at an interactive node corresponding to the first image; and
updating the currently displayed image from the first image to the second image.

According to at least one embodiment of the present disclosure, Example 2 is the method according to Example 1, where before the receiving a current trigger operation from an online user, the method further includes:
determining a historical trigger operation corresponding to at least one historical video frame in a historical interactive video, where the historical trigger operation is a trigger operation performed by the offline user at an interactive node corresponding to the corresponding historical video frame.

According to at least one embodiment of the present disclosure, Example 3 is the method according to Example 2, where the determining a historical trigger operation corresponding to at least one historical video frame in a historical interactive video includes:
separately identifying operation identification information displayed in the at least one historical video frame in the historical interactive video; and
using a trigger operation corresponding to the operation identification information as the historical trigger operation corresponding to the corresponding historical video frame.

According to at least one embodiment of the present disclosure, Example 4 is the method according to Example 3, where the operation identification information is displayed in the form of a color block image, color block images corresponding to different trigger operations have different display states, and the trigger operations include the historical trigger operation.

According to at least one embodiment of the present disclosure, Example 5 is the method according to Example 4, where the color block images corresponding to the different trigger operations have different colors, and the separately identifying operation identification information displayed in the at least one historical video frame in the historical interactive video includes:
for each of the at least one historical video frame in the historical interactive video, identifying a historical color block image displayed in a preset area of the historical video frame, and determining a plurality of color component values for a center pixel in the historical color block image;
separately determining component value intervals in which the plurality of color component values are located; and
using characteristic component values of the plurality of component value intervals as the operation identification information displayed in the historical video frame, where different component value intervals have different characteristic component values.

According to at least one embodiment of the present disclosure, Example 6 is the method according to any one of Examples 3 to 5, and the method further includes:
generating a video frame containing the first image, and writing operation identification information of the current trigger operation and operation identification information of the target historical trigger operation into the video frame to obtain a target video frame corresponding to the first image, to generate a target interactive video based on target video frames corresponding to a plurality of target images, where the plurality of target images include the first image and the second image.

According to at least one embodiment of the present disclosure, Example 7 is the method according to Example 2, where the determining a historical trigger operation corresponding to the at least one historical video frame in a historical interactive video includes:
obtaining, from a server, operation identification information corresponding to the at least one historical video frame in the historical interactive video; and
using a trigger operation corresponding to the operation identification information as the historical trigger operation corresponding to the corresponding historical video frame.

According to at least one embodiment of the present disclosure, Example 8 provides a display apparatus, which includes:
an operation receiving module configured to receive a current trigger operation from an online user;
an object control module configured to control a corresponding object to be controlled in a currently displayed first image based on the current trigger operation and a target historical trigger operation to obtain a second image, where the target historical trigger operation is a historical trigger operation performed by an offline user at an interactive node corresponding to the first image; and
an image update module configured to update the currently displayed image from the first image to the second image.

According to at least one embodiment of the present disclosure, Example 9 provides an electronic device, which includes:
at least one processor: and
a memory configured to store at least one program, where
the at least one program, when executed by the at least one processor, causes the at least one processor to implement the display method according to any one of Examples 1 to 7.

According to at least one embodiment of the present disclosure, Example 10 provides a computer-readable storage medium having stored thereon a computer program that, when executed by a processor, causes the display method according to any one of Examples 1 to 7 to be implemented.

In addition, although the various operations are depicted in a specific order, it should be understood as requiring these operations to be performed in the specific order shown or in a sequential order. Under certain circumstances, multitasking and parallel processing may be advantageous. Similarly, although several specific implementation details are included in the foregoing discussions, these details should not be construed as limiting the scope of the present disclosure. Some features that are described in the context of separate embodiments can also be implemented in combination in a single embodiment. In contrast, various features described in the context of a single embodiment may alternatively be implemented in a plurality of embodiments individually or in any suitable subcombination.

Although the subject matter has been described in a language specific to structural features and/or logical actions of the method, it should be understood that the subject matter defined in the appended claims is not necessarily limited to the specific features or actions described above. In contrast, the specific features and actions described above are merely exemplary forms of implementing the claims.

1. A display method, comprising:
receiving a current trigger operation from an online user;
controlling a corresponding object to be controlled in a currently displayed first image based on the current trigger operation and a target historical trigger operation to obtain a second image, wherein the target historical trigger operation is a historical trigger operation performed by an offline user at an interactive node corresponding to the first image; and
updating the currently displayed image from the first image to the second image.

2. The method according to claim 1, before the receiving a current trigger operation from an online user, further comprising:
determining a historical trigger operation corresponding to at least one historical video frame in a historical interactive video, wherein the historical trigger operation is a trigger operation performed by the offline user at an interactive node corresponding to the corresponding historical video frame.

3. The method according to claim 2, wherein the determining a historical trigger operation corresponding to at least one historical video frame in a historical interactive video comprises:
separately identifying operation identification information displayed in the at least one historical video frame in the historical interactive video; and
using a trigger operation corresponding to the operation identification information as the historical trigger operation corresponding to the corresponding historical video frame.

4. The method according to claim 3, wherein the operation identification information is displayed in the form of a color block image, color block images corresponding to different trigger operations have different display states, and the trigger operations comprise the historical trigger operation.

5. The method according to claim 4, wherein the color block images corresponding to the different trigger operations have different colors, and the separately identifying operation identification information displayed in the at least one historical video frame in the historical interactive video comprises:
for each of the at least one historical video frame in the historical interactive video, identifying a historical color block image displayed in a preset area of the historical video frame, and determining a plurality of color component values for a center pixel in the historical color block image;
separately determining component value intervals in which the plurality of color component values are located; and
using characteristic component values of the plurality of component value intervals as the operation identification information displayed in the historical video frame, wherein different component value intervals have different characteristic component values.

6. The method according to claim 3, further comprising:
generating a video frame containing the first image, and writing operation identification information of the current trigger operation and operation identification information of the target historical trigger operation into the video frame to obtain a target video frame corresponding to the first image, to generate a target interactive video based on target video frames corresponding to a plurality of target images, wherein the plurality of target images comprise the first image and the second image.

7. The method according to claim 2, wherein the determining a historical trigger operation corresponding to the at least one historical video frame in a historical interactive video comprises:
obtaining, from a server, operation identification information corresponding to the at least one historical video frame in the historical interactive video; and
using a trigger operation corresponding to the operation identification information as the historical trigger operation corresponding to the corresponding historical video frame.

8. (canceled)

9. An electronic device, comprising:
at least one processor; and a memory configured to store at least one program, wherein the at least one program, when executed by the at least one processor, causes the at least one processor to:
receive a current trigger operation from an online user;
control a corresponding object to be controlled in a currently displayed first image based on the current trigger operation and a target historical trigger operation to obtain a second image, wherein the target historical trigger operation is a historical trigger operation performed by an offline user at an interactive node corresponding to the first image; and
update the currently displayed image from the first image to the second image.

10. A non-transitory computer-readable storage medium having stored thereon a computer program that, when executed by a processor, causes the the processor to:
receive a current trigger operation from an online user;
control a corresponding object to be controlled in a currently displayed first image based on the current trigger operation and a target historical trigger operation to obtain a second image, wherein the target historical trigger operation is a historical trigger operation performed by an offline user at an interactive node corresponding to the first image; and
update the currently displayed image from the first image to the second image.

11. The electronic device according to claim 9, before the at least one program causes the processor to receive a current trigger operation from an online user, the at least one program further causes the processor to:
determine a historical trigger operation corresponding to at least one historical video frame in a historical interactive video, wherein the historical trigger operation is a trigger operation performed by the offline user at an interactive node corresponding to the corresponding historical video frame.

12. The electronic device according to claim 11, wherein the at least one program that causes the processor to determine the historical trigger operation corresponding to at least one historical video frame in a historical interactive video comprises program that causes the processor to:
separately identifying operation identification information displayed in the at least one historical video frame in the historical interactive video; and
using a trigger operation corresponding to the operation identification information as the historical trigger operation corresponding to the corresponding historical video frame.

13. The electronic device according to claim 12, wherein the operation identification information is displayed in the form of a color block image, color block images corresponding to different trigger operations have different display states, and the trigger operations comprise the historical trigger operation.

14. The electronic device according to claim 13, wherein the color block images corresponding to the different trigger operations have different colors, and the at least one program that causes the processor to separately identify operation identification information displayed in the at least one historical video frame in the historical interactive video comprises program that causes the processor to:
for each of the at least one historical video frame in the historical interactive video, identify a historical color block image displayed in a preset area of the historical video frame, and determining a plurality of color component values for a center pixel in the historical color block image;
separately determine component value intervals in which the plurality of color component values are located; and
use characteristic component values of the plurality of component value intervals as the operation identification information displayed in the historical video frame, wherein different component value intervals have different characteristic component values.

15. The electronic device according to claim 12, wherein the at least one program further causes the processor to:
generate a video frame containing the first image, and write operation identification information of the current trigger operation and operation identification information of the target historical trigger operation into the video frame to obtain a target video frame corresponding to the first image, to generate a target interactive video based on target video frames corresponding to a plurality of target images, wherein the plurality of target images comprise the first image and the second image.

16. The electronic device according to claim 11, wherein the at least one program that causes the processor to determine a historical trigger operation corresponding to the at least one historical video frame in a historical interactive video comprises program that cause the processor to:
obtain, from a server, operation identification information corresponding to the at least one historical video frame in the historical interactive video; and
use a trigger operation corresponding to the operation identification information as the historical trigger operation corresponding to the corresponding historical video frame.

17. The non-transitory computer-readable storage medium according to claim 10, before the at least one program causes the processor to receive a current trigger operation from an online user, the at least one program further causes the processor to:
determine a historical trigger operation corresponding to at least one historical video frame in a historical interactive video, wherein the historical trigger operation is a trigger operation performed by the offline user at an interactive node corresponding to the corresponding historical video frame.

18. The non-transitory computer-readable storage medium according to claim 17, wherein the at least one program that causes the processor to determine the historical trigger operation corresponding to at least one historical video frame in a historical interactive video comprises program that causes the processor to:
separately identifying operation identification information displayed in the at least one historical video frame in the historical interactive video; and
using a trigger operation corresponding to the operation identification information as the historical trigger operation corresponding to the corresponding historical video frame.

19. The non-transitory computer-readable storage medium according to claim 18, wherein the operation identification information is displayed in the form of a color block image, color block images corresponding to different trigger operations have different display states, and the trigger operations comprise the historical trigger operation.

20. The non-transitory computer-readable storage medium according to claim 19, wherein the color block images corresponding to the different trigger operations have different colors, and the at least one program that causes the processor to separately identify operation identification information displayed in the at least one historical video frame in the historical interactive video comprises program that causes the processor to:
for each of the at least one historical video frame in the historical interactive video, identify a historical color block image displayed in a preset area of the historical video frame, and determining a plurality of color component values for a center pixel in the historical color block image;
separately determine component value intervals in which the plurality of color component values are located; and
use characteristic component values of the plurality of component value intervals as the operation identification information displayed in the historical video frame, wherein different component value intervals have different characteristic component values.

21. The non-transitory computer-readable storage medium according to claim 18, wherein the at least one program further causes the processor to:
generate a video frame containing the first image, and write operation identification information of the current trigger operation and operation identification information of the target historical trigger operation into the video frame to obtain a target video frame corresponding to the first image, to generate a target interactive video based on target video frames corresponding to a plurality of target images, wherein the plurality of target images comprise the first image and the second image.
